(19) United States
(12) Patent Application Publication
(10) Pub. No.: US 2002/0061506 A1
(43) Pub. Date: May 23, 2002

(54) Authoring and delivering training courses

(75) Inventors: J. Corey Catten, West Valley City, UT (US); Chad Adams, North Heber, UT (US); Bill Baird, Sandy, UT (US); Bryant Bunderson, Sandy, UT (US); Eric R. Capps, Sandy, UT (US); Rob Gray, Murray, UT (US); Ian Hamilton, Salt Lake City, UT (US); Cory Stokes, Salt Lake City, UT (US); Vinh Vo, Salt Lake City, UT (US); Sue Hall, Salt Lake City, UT (US); Grant Echols, Payson, UT (US); Todd Frazier, Salt Lake City, UT (US); Bryan Chapman, Sandy, UT (US); Colleen Jennings, Salt Lake City, UT (US); Mark Minaga, South Jordan, UT (US)

Correspondence Address: DAVID B. DELLENBACH, WORKMAN NYDEGGER & SEELEY, 1000 EAGLE GATE TOWER, 60 EAST SOUTH TEMPLE, SALT LAKE CITY, UT, 84111, US

(73) Assignee: Avaltus, Inc.

(21) Appl. No.: 09/847,650

(22) Filed: May 2, 2001

Related U.S. Application Data
(60) Provisional application No. 60/201,500, filed on May 3, 2000.

(51) Int. Cl. G09B 25/00

(52) U.S. Cl. 434/369

(57) ABSTRACT

Systems and methods for delivering a training course whose content is independent of the delivery technology and whose content is deliverable in future delivery technologies without significantly rewriting or recoding the training course. For a training course, an XML version of the content of the training course is generated. The XML version of the content can be accessed through a content module which provides an interface to a viewer that corresponds to a selected delivery technology. The same content can be provided through different delivery technologies by using the appropriate viewer. This preserves the viability and life of the content because it is easily adapted to different delivery technologies. A graphic treatment for the content is also independent and separately changeable. Also, a instruction strategy for determining how to present the content is provided.

### CROSS-REFERENCES TO RELATED APPLICATIONS

This application claims the benefit of U.S. Provisional Application No. 60/201,500, filed May 3, 2000 and entitled “Course Authoring Engine and Courseware,” which is incorporated herein by reference in its entirety.

### BACKGROUND OF THE INVENTION

1. The Field of the Invention

The present invention relates to systems and methods for delivering a training course or program. More particularly, the present invention relates to systems and methods for delivering a training course whose content is independent of the technology in which the content of the training course is delivered.

2. Background and Related Art

Employee training is an important aspect of many businesses and institutions. Training courses or programs have a significant role in teaching employees about their job and their responsibilities. Training is often provided, for example, that teaches employees how to perform tasks that they perform on a daily basis and how to perform tasks that are expected of all employees, such as punching a time clock. Training is also provided that teaches employees how to perform other job specific tasks or functions that may be encountered on the job for which they have responsibility and training courses also teach employees how to respond when faced with an emergency such as a fire.

Employee training is especially important today because employees are often expected to operate technologically advanced equipment and training courses are intended to teach jobs both functionally and factually with the overall goal of helping employees better perform their jobs while improving their performance. Today, many training courses or programs are presented using computers and computer related technologies. Training courses are also produced using computers and computer related technologies and the following example generally illustrates how a training course is created.

The process of creating a training course begins when a training need is identified. This occurs, for example, when a company introduces a new department, introduces a new product, or simply desires to provide corporate education. After the need is identified, an audience analysis is performed. The audience analysis examines the population that will be receiving the training course by taking into account factors such as the population's age and level of education.

A curriculum design follows the audience analysis. The curriculum design generally focuses on how the information of the training course is to be presented to the population. Textbooks, for example, are the results of a curriculum design. While textbooks are usually used in an academic setting to increase knowledge, training courses are usually in a work related setting and are intended to increase the competency of the population. Training courses, however, are not precluded from being used in other settings including an academic setting.

The curriculum design takes into account the jobs or functions to be performed by the population as well as their responsibilities. For example, a curriculum design for a cashier examines the necessary competencies of a cashier and the curriculum design is intended to teach these competencies to the cashier receiving the training. For example, cashiers must receive tender, make change, process credit cards, check identification, and the like. These functions and responsibilities are incorporated into a curriculum design.

After the audience analysis and the curriculum design have been accomplished, a computer program that will execute the training course is created. The training courses are complex programs that incorporate multimedia, text, video, animations and the like. Even though the path of a training course is scripted by instructional or curriculum designers, programmers are required to actually write code for the training course. In the meantime, the audio and video that is incorporated into the training course is being produced by others who have expertise in that area. Producing a training course is thus a complex process that requires a significant investment from all persons (programmers, instructional designers, actors, etc.) that are involved.

In spite of the benefits that training courses provide, there are significant difficulties that are often encountered by companies that produce training courses as well as those that ultimately use the training courses. Generally stated, training courses are hard to manage, are not portable from one technology to another, and are created in a pseudo programming environment. In addition, most training course are essentially written from the beginning without having the benefit of using work that has already been performed.

Several different tools have been developed in an attempt to address these issues. These tools are authoring tools that are intended to make the process of creating and producing a training course more simple. These tools vary from tools that an every day user can use to tools that require programming skills. While these tools often help in the creation of a particular training course, they do not address the needs of manageability and portability.

For example, many training courses include multiple choice questions and tools have been developed that provide code for asking a multiple choice question. The developer of the training course only needs to insert the pre-created code into the training course each time that a multiple choice question is asked.

This is often problematic from a software engineering perspective because the inserted code does not necessarily provide proper encapsulation with respect to the training course being developed. In other words, the boundary conditions of the inserted code are not well defined. This problem is most evident when the customer asks that particular questions in the training course be changed or removed. A change to some questions or the removal of a question often creates ripple effects that cause the training course to malfunction at some point. Because of these ripple effects, the entire process of quality assurance for the entire training course must be re-performed even when the substantive change to the training course is relatively small and minor.

Another problem often associated with these development tools is that it is difficult to use part of an existing training course in another training course. For example, a training course for cashiers may include a portion that teaches cashiers how to use a time clock. This portion of the training course is not necessarily usable in a training course for other employees because the portion of the training course that addresses use of the time clock by the cashier is integrated with the rest of the training course for the cashier and cannot be easily extracted for use in other training courses. For this reason, it is difficult to successfully lift a portion from one training course and insert it in another training course.

Training courses are usually created using the best tool for a particular job. Unfortunately, once a training course has been created, it cannot be converted to another format. In other words, training courses are not portable from one technology to another technology and are not prepared for future technologies. This is similar to the problems that are experienced when a word processing document created in one word processor is opened using another word processor but on a much larger scale.

For example, assume that a company initially wants a training course that demonstrates how to use a computer mouse and that the company wants the training course to be written using a particular technology such that it may be delivered over the Internet. If the company later decides that it wants the training course for the computer mouse to be presented in an environment that does not have Internet access, the training course will have to be substantially re-created in its entirety because the training course lacks portability and because the training course is embedded in a particular technology.

If a company or other institution wants a training course to be created and presented in a variety of different formats and/or technologies, the training course is re-created or rewritten for each format and for each technology. Not only does this significantly increase the cost of producing a training course, but it is also extremely difficult to ensure that the training course can be easily adapted to future technologies. Thus, managing the use and development of a sustainable training course is a difficult assignment.

Because many training courses are created in a pseudo programming environment, it is difficult for someone not familiar with the training course to alter it because they do not really know or understand how the training course was created and do not know what tools were used to write the training course. Thus, training courses are hard to manage, are not portable from one technology to another, are created in a pseudo programming environment, and are not deliverable in future technologies.

Another problem associated with training courses is related to authoring the content of a training course. The content is usually produced using a single document approach. In a single document approach, each author is conceptually using a different document that will be combined with the documents of the other authors at a later date. The work of the different authors is often combined, for example, using cut and paste methods. In some instances, a notification system that notifies a waiting content author that a first content author has finished their edits to the content can be employed, at which time the waiting content author can access and edit the content. This, obviously, requires all content authors to wait on a particular content author. Of course, each content author can work with a copy of the original, but as previously described, additional work is required to combine the efforts of multiple content authors. Thus, authoring and delivering training courses is further complicated by the fact that content is not easily edited by multiple authors in addition to being embedded in the delivery technology.

### SUMMARY OF THE INVENTION

The content of training courses is often viable for several years. Unfortunately, delivery technology is rapidly changing and as a result, training courses are often rewritten not to improve the content of the training course, but to adapt the training courses to newer technologies and to overcome the limitations of older technologies. These and other problems are overcome by the present invention, which relates to systems and methods for delivering training courses and/or training content through multiple delivery technologies. The present invention also relates to systems and methods for authoring the content of the training courses.

In accordance with the present invention, training courses can be delivered through different technologies primarily because the content of the training courses is separate and independent of the delivery technology. For this reason, the content can be deployed through different delivery technologies without having to significantly alter the content of the training course. Significantly, the independence of the content of the training courses allows the content be delivered through technologies that are not currently available. Thus, the life and viability of a training course is not overly compromised by future developments in delivery technologies.

In one embodiment, the graphic treatment of a particular training course is also separate and independent of both the content and the delivery technology. The separateness of the graphic treatment allows the look and the feel of the training course to be varied at any point (including run time of the training course) and the development of the training course is not impeded and does not need to be rewritten if a particular graphic treatment is discarded and a new graphic treatment is selected.

Once the content of a training course has been developed, it is in condition for deployment or delivery. During delivery, the content is presented through a designated delivery technology such as, for example, a web based system, a stand alone system, or the like. The graphic treatment is applied to the content of the training course during delivery.

The training course also includes an instruction strategy, which is another independent aspect of the training course. The instruction strategy determines how the content of the training course can be navigated by various populations or audiences. A training course can implement multiple instruction strategies to accommodate different training groups and audiences.

Additional features and advantages of the invention will be set forth in the description which follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates an exemplary system that provides a suitable operating environment for the present invention;

FIG. 2 is a block diagram illustrating the organization of the content of one or more training courses;

FIG. 3 is a block diagram that illustrates the separateness and independence of the instruction strategy, content, graphic treatment, and delivery of a particular training course;

FIG. 4 is a block diagram that more fully details the independence of the content of a training course as well as how different delivery technologies and graphic treatments are selected;

FIG. 5 is a block diagram that illustrates exemplary modules or components of a system for delivering content through multiple technologies;

FIG. 6 is a block diagram that illustrates a training course that has been deployed to a customer;

FIGS. 7A and 7B are a screen shot of a content manager used to manage the content of a training course and also illustrates an exemplary view of the structure of the content;

FIG. 8 is a block diagram illustrating the general XML format of the content of a training course; and

FIG. 9 is a block diagram illustrating the general XML format of the content for a particular question in the content of a training course.

### DETAILED DESCRIPTION OF THE PREFERRED EMBODIMENTS

A primary purpose for creating and using a training course is to improve and enhance, for example, the skills, competency, and/or knowledge of the population or audience that receives the training course. Unfortunately, the content is typically embedded in the delivery technology, which causes problems of continuity and portability as previously described. The present invention provides systems and methods that alleviate and overcome these and other problems associated with training courses.

In accordance with the present invention, the content of the training courses is independent and separate from other aspects or modules of the training courses, including the delivery technology. As a result, the content is not embedded in any particular technology and can be readily redeployed in different technologies without having to rewrite or recode the entire training course or even portions of the training course for the various technologies. In addition, the separateness and independence of the content allows it to be delivered in future technologies without having to develop and write a new training course for that technology. Instead, the existing content is simply deployed to the new technology.

Another advantage of one embodiment of the present invention is that the graphic treatment of a training course is also independent and separable from both the content and the delivery technology. Again, this provides a purchaser of the training course with flexibility during the development of the training course and allows the look and feel to be changed at will with minimal effort. The independence of the content, delivery technology and graphic treatment provide the additional advantage of allowing a customer to delay decisions that were previously made early in the process of developing a training course. For instance, once a particular graphic treatment or delivery technology had been chosen, it is typically very difficult to change that decision without significant effort which could involve a rewrite of the training course. In contrast, the present invention allows the graphic treatment to be selected at any time and can be selected even after the training course is completed.

The present invention extends to both methods and systems for creating or delivering the content of a training course. The embodiments of the present invention may comprise a special purpose or general-purpose computer including various computer hardware, as discussed in greater detail below.

Embodiments within the scope of the present invention also include computer-readable media for carrying or having computer-executable instructions or data structures stored thereon. Such computer-readable media can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures and which can be accessed by a general purpose or special purpose computer.

When information is transferred or provided over a network or another communications connection (either hardwired, wireless, or a combination of hardwired or wireless) to a computer, the computer properly views the connection as a computer-readable medium. Thus, any such connection is properly termed a computer-readable medium. Combinations of the above should also be included within the scope of computer-readable media. Computer-executable instructions comprise, for example, instructions and data which cause a general purpose computer, special purpose computer, or special purpose processing device to perform a certain function or group of functions.

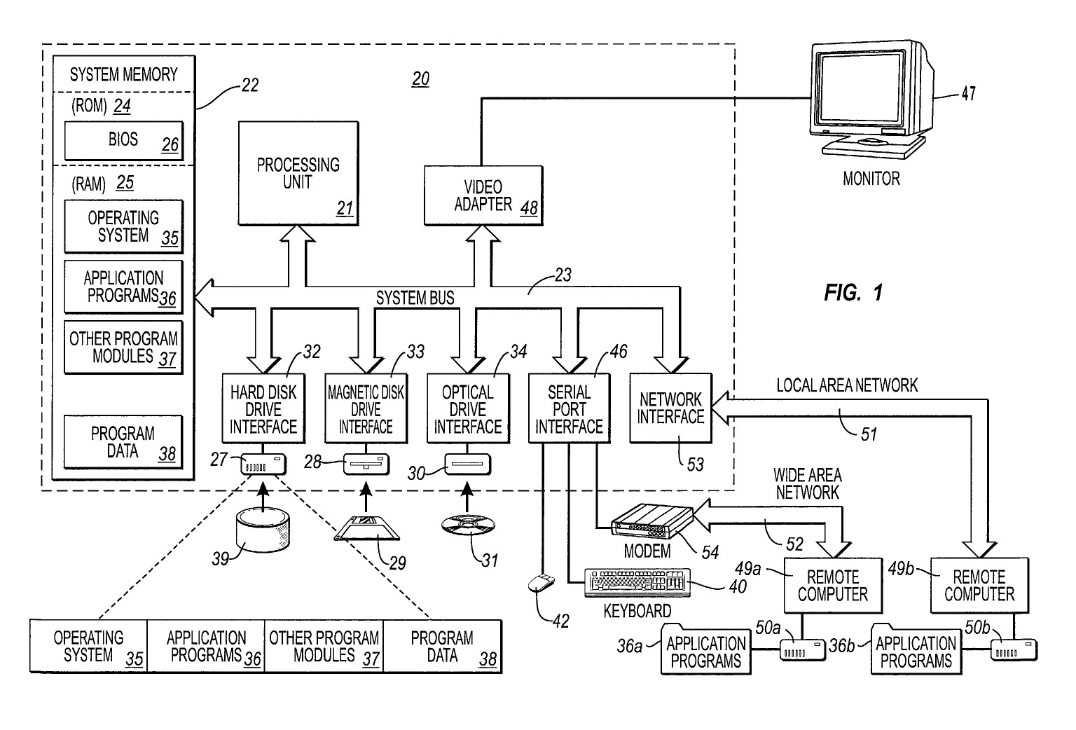

FIG. 1 and the following discussion are intended to provide a brief, general description of a suitable computing environment in which the invention may be implemented. Although not required, the invention will be described in the general context of computer-executable instructions, such as program modules, being executed by computers in network environments. Generally, program modules include routines, programs, objects, components, data structures, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Those skilled in the art will appreciate that the invention may be practiced in network computing environments with many different types of computer system configurations, including, for example, personal computers, hand-held devices, multiprocessor systems, microprocessor-based or programmable consumer electronics, network PCs, minicomputers, mainframe computers, and the like. The invention may also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

With reference to FIG. 1, an exemplary system for implementing the invention includes a general purpose computing device in the form of a conventional computer 20, including a processing unit 21, a system memory 22, and a system bus 23 that couples various system components including the system memory 22 to the processing unit 21. The system bus 23 may be any of several types of bus structures including a memory bus or memory controller, a peripheral bus, and/or a local bus using any of a variety of bus architectures. The system memory includes read only memory (ROM) 24 and random access memory (RAM) 25. A basic input/output system (BIOS) 26, containing the basic routines that help transfer information between elements within the computer 20, such as during start-up, may be stored in ROM 24.

The computer 20 may also include a magnetic hard disk drive 27 for reading from and writing to a magnetic hard disk 39, a magnetic disk drive 28 for reading from or writing to a removable magnetic disk 29, and/or an optical disk drive 30 for reading from or writing to removable optical disk 31 such as a CD-ROM or other optical media. The magnetic hard disk drive 27, magnetic disk drive 28, and/or optical disk drive 30 are connected to the system bus 23 by a hard disk drive interface 32, a magnetic disk drive-interface 33, and an optical drive interface 34, respectively. The drives and their associated computer-readable media provide nonvolatile storage of computer-executable instructions, data structures, program modules and other data for the computer 20. Although the exemplary environment described herein employs a magnetic hard disk 39, a removable magnetic disk 29 and/or a removable optical disk 31, other types of computer readable media for storing data can be used, including magnetic cassettes, flash memory cards, digital versatile disks, Bernoulli cartridges, RAMs, ROMs, and the like, for example.

Program code means comprising one or more program modules may be stored on the hard disk 39, magnetic disk 29, optical disk 31, ROM 24 or RAM 25, including an operating system 35, one or more application programs 36, other program modules 37, and program data 38. A user may enter commands and information into the computer 20 through keyboard 40, pointing device 42, or other input devices (not shown), such as a microphone, joy stick, game pad, satellite dish, scanner, or the like. These and other input devices are often connected to the processing unit 21 through a serial port interface 46 coupled to system bus 23. Alternatively, the input devices may be connected by other interfaces, such as a parallel port, a game port or a universal serial bus (USB). A monitor 47 or another display device is also connected to system bus 23 via an interface, such as video adapter 48. In addition to the monitor, personal computers typically include other peripheral output devices (not shown), such as speakers and printers.

The computer 20 may operate in a networked environment using logical connections to one or more remote computers, such as remote computers 49a and 49b. Remote computers 49a and 49b may each be another personal computer, a server, a router, a network PC, a peer device or other common network node, and typically include many or all of the elements described above relative to the computer 20, although only memory storage devices 50a and 50b and their associated application programs 36a and 36b have been illustrated in FIG. 1. The logical connections depicted in FIG. 1 include a local area network (LAN) 51 and a wide area network (WAN) 52 that are presented here by way of example and not limitation. Such networking environments are commonplace in office-wide or enterprise-wide computer networks, intranets and the Internet.

When used in a LAN networking environment, the computer 20 is connected to the local network 51 through a network interface or adapter 53. When used in a WAN networking environment, the computer 20 may include a modem 54, a wireless link, or other means for establishing communications over the wide area network 52, such as the Internet. The modem 54, which may be internal or external, is connected to the system bus 23 via the serial port interface 46. In a networked environment, program modules depicted relative to the computer 20, or portions thereof, may be stored in the remote memory storage device. It will be appreciated that the network connections shown are exemplary and other means of establishing communications over wide area network 52 may be used.

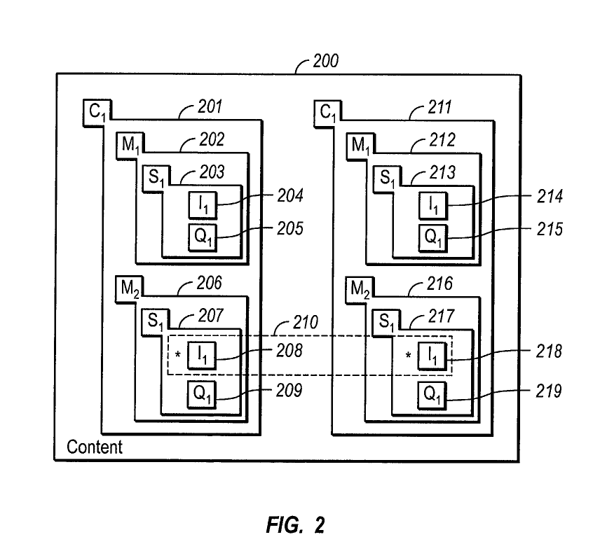

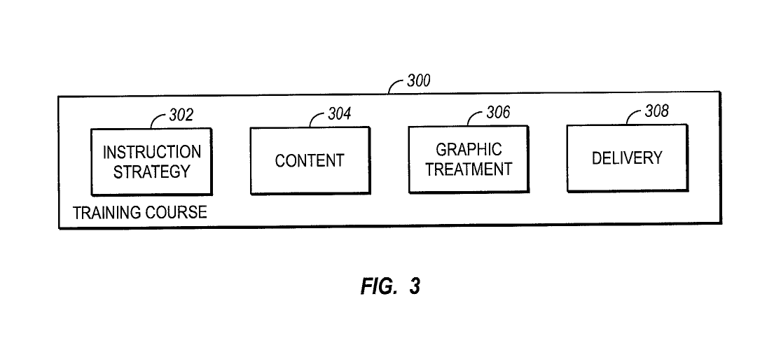

FIG. 2 is a block diagram that illustrates both the content of one or more training courses and an example of how the content of those courses may be organized. The content 200 is representative of the information or data that can be included in a training course. The content 200 represents the content of multiple courses, but a training course is typically limited to the content that corresponds to that training course, as is described in FIG. 3. The content 200 is organized into courses and FIG. 2 illustrates the content of both course 201 and course 211. Thus, the course 201 represents the content of a particular training course and the course 211 represents the content of another training course. A training course, as described in more detail below, has other components in addition to the content that is described in FIG. 2. It is understood that the content 200 can contain the content of multiple courses.

The content of each course is arranged hierarchically into basic elements or templates including, but not limited to, modules, segments, and blocks. Modules include segments and blocks while segments include blocks. When the courses, modules, segments, and blocks are described in terms of elements or templates, there are three types: information templates, question templates, and container templates. The information templates are typically used to store information that has no concept of right or wrong, they are used to convey informative and instructional data in some form. Information templates thus store data and the blocks 204, 208, 214, and 218 are exemplary information templates. Question templates, on the other hand, usually do have a concept of right or wrong and are often used to test the knowledge or competency of the trainee. Exemplary question templates are blocks 205, 209, 215 and 219. Information templates and question templates can present data to a user or to a group of users in a wide variety of ways. Block 204, for example, can include one or more of video, text, graphics and other types of data or media, or any combination thereof.

Container templates are used to store or hold information templates and question templates as well as other container templates. Container templates, such as segments and modules, further the modularity of design. Segments often group related information templates and question templates while modules further group related segments. Thus, segments, modules, and courses are often container templates.

For example, segment 203 is a container template because it contains block 204 which is an information template and block 205 which is a question template. Module 202 is also a container template and stores an information template (block 204), a question template (block 205), and a container template (segment 203). Each block, segment, module, and course in FIG. 2 can be similarly described in this manner.

The content of the courses illustrated in FIG. 2 is exemplary, and typical content is not limited to the number of modules, segments and blocks illustrated in FIG. 2. Rather, the content of each course can have multiple modules, multiple segments within each module and multiple blocks within each segment. It is also understood that FIG. 2 is an example of how content may be organized, but it is not a requirement to organize content in this manner. In all cases, however, the content 200 is not embedded in any particular technology and is separate and independent from the other aspects of a training course, including, but not limited to, the graphic treatment, the instruction strategy and the delivery technology.

FIG. 2 also illustrates alias elements 210. Aliasing, as used herein, implies that the content of multiple courses can be updated by updating the content of a particular course. Because the content 200 of the various courses is independent and because the content of many courses may be substantially similar if not identical, the courses, modules, segments and blocks can be freely copied, moved or aliased. The advantage of an aliased copy is that changes made to any single copy are reflected in each of the aliased copies. Thus, if changes are made to the block 208, which is aliased in block 218, those same changes are manifest in the block 218. This allows many courses to be quickly and easily updated without having to update each separate course, module, segment, or block independently. Within any group of aliased copies, any single block (or segment, module and course) can be separated from the other aliased copies such that changes made to the separated block are not reflected in the remaining aliased blocks. The separated copy is no longer aliased in this case, but the remaining blocks, however, typically remain aliased.

FIG. 3 is a block diagram that illustrates a training course and further illustrates the independence of each component or module of the training course. The training course 300 includes an instruction strategy 302, content 304, graphic treatment 306 and delivery 308. As previously stated, the independence and separateness of each module ensures that training courses do not become outdated by advances in technology and that a training course remains viable and usable by the purchaser. The content 304 is typically limited to the content of the training course 300. Thus, the content 304 may correspond, for example, to the content of the course 201 which is shown in FIG. 2.

For each training course, an instruction strategy 302 is usually developed. The instruction strategy 302, for instance, ensures that content can be effectively presented to different audiences or populations. The instruction strategy 302 thus relates to the rules under which a particular training course is presented. The instruction strategy 302 contemplates, for example, the consequences of missing a question. The instruction strategy 302 determines whether a user receives another chance to correctly answer a missed question or requires the user to review the information that relates to the missed question.

The instruction strategy 302 also relates to how a particular training course is navigated by a user by presenting various navigation tools to the user. The instruction strategy 302 determines whether a user is allowed to go back to a previous screen or whether a user can skip, for example, a segment or a module of a training course. A single training course can include multiple instruction strategies that can be selected according to the audience or population that receives the training course.

For example, assume that a training course was developed to teach a course on sexual harassment. In addition, assume that the training course was being presented to a group (group A) of people that specialize in the treatment of sexual harassment as well as to a different group (group B) of people that have no extensive knowledge of the treatment of sexual harassment. The content presented to group A is the same as the content presented to group B, but the instruction strategy is separate and different for each group. The instruction strategy 302 may permit group A to skip certain modules, segments or blocks of the training course while group B is not allowed to skip any of the modules, segments or blocks of the training course. This can be accomplished, for example, by providing group A with navigation buttons that allow them, for instance, to skip to the next module of the training course while group B is only presented with a next button that takes them to the next portion of the training course.

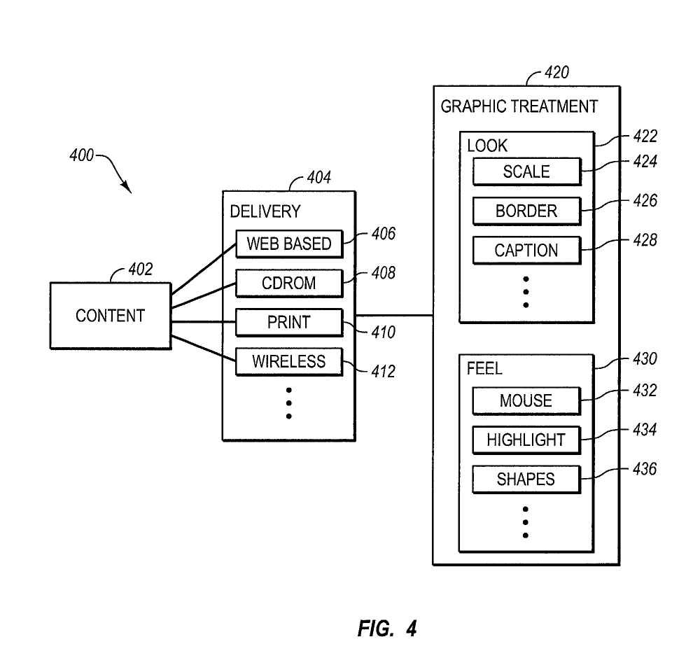

The content 304 is the information or data included in the training course 300 and includes, as previously described, text, audio, video, interactive elements, multimedia and the like and any combination thereof. The content 304 reflects the curriculum design. The graphic treatment 306 is another independent component or portion of the training course 300. As used herein, “graphic treatment” refers to the look and/or the feel of the training course and is described in more detail in FIG. 4. The delivery 308 is the technology through which the training course 300 is delivered to a trainee. In one embodiment, the delivery 308 is also an independent and separate module of the training course 300.

The independence and separateness of the components or modules of the training course 300 is an advantage because of the resulting flexibility. For example, because the content 304 is independent of the delivery 308, the concern that the training course 300 will not function with future technologies is alleviated. Instead, the content 304 is easily adapted and delivered to new or different technologies. Thus the same content can be delivered to a print system or to a web based system. The graphic treatment 306 is applied to the content as the content is delivered and can be changed at will without having to recreate or rewrite the training course 300. The instruction strategy 302 can also be selected to work with any content, graphic treatment or delivery.

When the content is delivered to a delivery technology, the graphic treatment is applied. For example, when a question is delivered, the graphic treatment is applied based on rules that are either pre-defined or set by a user for example. The rules can be changed or altered as needed and can vary from question to question, block to block or as needed. The following example describes how some aspects of the graphic treatment may be applied to content. If a question is being delivered, the question stem may be placed on the top of the screen and left justified. The question choices may be centered in the screen below the question stem and spread out for a pleasing look. Boxes, in which a user may indicate their answer choice, are often placed to the left of each choice. Other graphics can be placed at various locations of the screen. In this manner, the graphic treatment may be applied to the content. In a similar manner, the instruction strategy can also be applied to the content as it is delivered.

FIG. 4 is a block diagram that more fully illustrates the flexibility provided by the present invention. FIG. 4 illustrates the content 402 of a training course or program. The delivery 404 represents the technology through which the training course is delivered and presented. Exemplary deliveries include, but are not limited to, web-based delivery 406, CDROM delivery 408, print delivery 410 and wireless delivery 412. The content 402 is not embedded in nor is it dependent on the delivery 404. Thus, the delivery 404 can be selected at any time during the development of the content and/or the training course.

By making the delivery 404 independent of the content 402, a customer can have the content delivered in more than one technology and the customer can change their mind about how the content is to be delivered without having the training course rewritten or recoded for the newly selected delivery technology. In addition, the content 402 is prepared for future delivery technologies, even though those delivery technologies may be unknown, without having to redevelop the training course.

FIG. 4 also provides more detail on the graphic treatment 420 of the training course, which is selectable by a customer. All items associated with the graphic treatment 420 are independent and can be selected or specified by a customer at any time including run time. This is advantageous because the look and feel do not have to be fixed or selected before the training course is developed and the look and feel can be altered with minimal effort without the expense of rewriting the training course that would otherwise be incurred when a different graphic treatment is selected.

In this example, the graphic treatment 420 includes both the look 422 and the feel 430. The look 424 includes, but is not limited to, items such as scale 424, border 426, and caption 428. More specifically, the look 422 addresses issues such as whether items are scalable, whether a caption is included, the font of the caption, how objects or text are justified, whether a drop shadow is included, and the like. The feel 430 includes items including, but not limited to, mouse 432, highlight 434, and shapes 436. For example, the feel 430 addresses issues such as whether the mouse changes to a hand at certain times or locations, whether a button highlights or depresses when it is clicked, and the like. As previously stated, however, an important advantage of the graphic treatment 420 is that it is independent of the content 402 and the delivery 404 and can be altered at any time. The graphic treatment 306 can even be altered at run time.

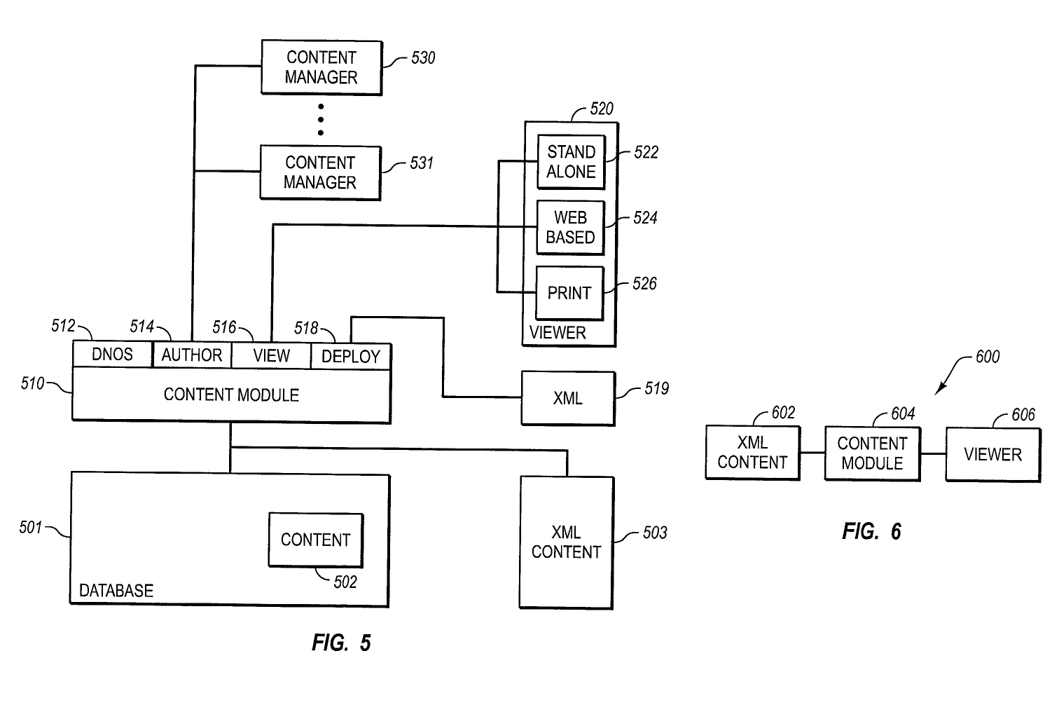

FIG. 5 is a block diagram that illustrates systems and methods for delivering a training course whose content is independent of the delivery technology. FIG. 5 illustrates a database 501 that stores the content 502, which as previously described, contains one or more training courses or programs. The Extensible Markup Language (XML) content 503 is essentially identical to the content 502 except that it is in an XML format. The XML format of the content 502 is partly responsible for allowing the content of the training courses to be independent of the delivery technology,

FIG. 5 further illustrates a content module 510 that provides various interfaces to the content 502 stored in the database 501. The distributed named object system (DNOS) interface 512 is responsible for allowing content to be found or accessed in the database 501. Courses generally have names by which they are known and referenced. A cashier course, for example, may be named “utility clerk training.” The DNOS interface 512 is able to receive this general name and map the general name to the content of the training course. The DNOS interface 512 can work with courses, modules, segments, or any other building blocks or templates. Thus, the DNOS interface 512 is also employed by other interfaces or modules of the content module 510. Different portions of the content of a particular course may be located on physically separate servers in different geographical locations and the DNOS interface 512 allows the content to be accessed appropriately without the user being concerned of the actual location of the content.

The view interface 516 is accessed by a viewer 520 to use the content 502 or the equivalent XML content 503. The viewer 520 corresponds to the technology in which the content 502 or XML content 503 is actually delivered to an end user or customer. Exemplary viewers 520 include, but are not limited to, stand alone viewer 522, web based viewer 524, and print viewer 526. Other viewers may include a wireless viewer and the like.

There are several differences between the various viewers. The web based viewer 524 may receive the content 502 through Hyper Text Markup Language (HTML) and other technologies that are often used with the Internet. The print viewer 526, on the other hand, is a printed copy of the content 502. The stand alone viewer 522 does not require access to a network and can be embodied on a CDROM.

Significantly, the content is not embedded in either the viewer or the delivery technology but is separate as previously described with reference to FIG. 4. Thus, if a user desires that a training course be delivered to a stand alone viewer 522 instead of a web based viewer 524, the content is readily available and a different viewer can be chosen even after the training course has been finished. This eliminates the requirement and cost of redeveloping the same training course for a different delivery technology. In addition, the training course is not limited to current delivery technologies, but can be delivered in future technologies that are either in development or are unknown. In a similar manner, as previously described, the graphic treatment of the training course is similarly independent and can be altered as needed because the graphic treatment is usually not applied to the content until it is delivered through a viewer 520. When the training course is executed, delivered, or viewed, then the selected graphic treatment is applied to the content as the content of the training course is presented through the viewer. In a similar manner, the instruction strategy can be applied as the content is delivered as well. Alternatively, the graphic treatment and instruction strategy can be applied before the content is delivered.

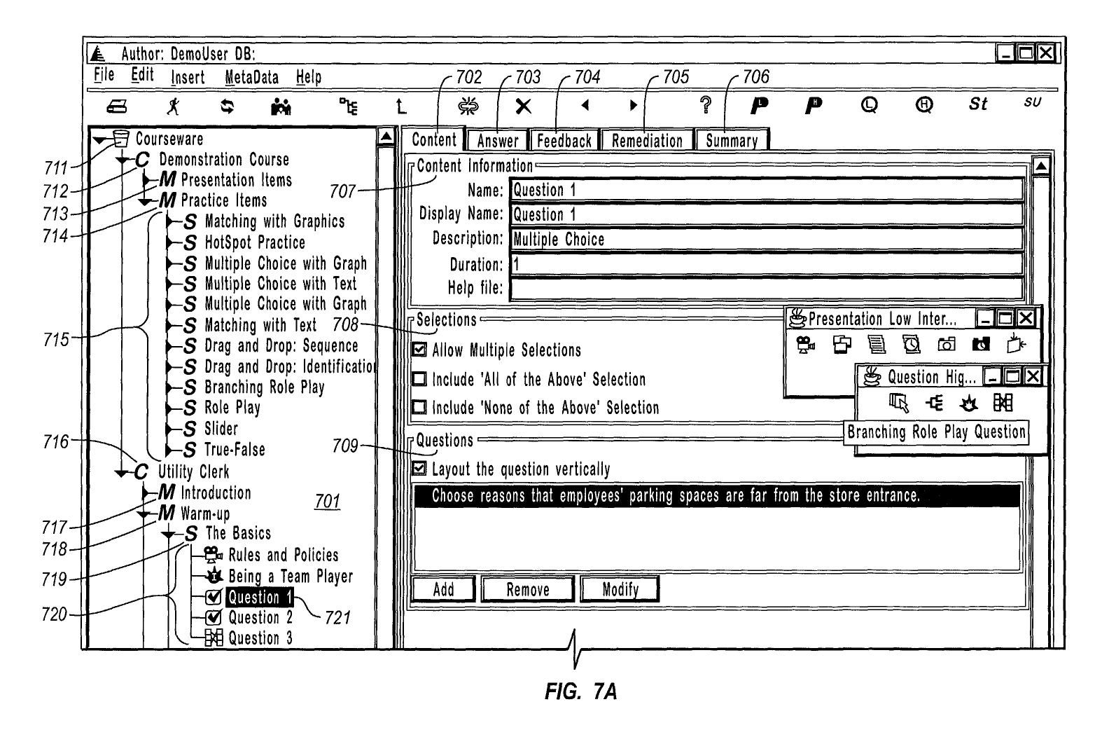

The deploy interface 518 is used to create an XML version 519 of a particular training course. When a particular training course is deployed, an XML version of the content of the training course is generated and the XML version 519 of the content can be adapted to various viewers as needed. FIG. 6, for example, represents how a training course may be delivered for use by a customer. The customer receives the XML content 602 of their training course as well as the content module 604. The content module 604 provides the necessary interfaces such that the content can be merged with the appropriate graphic treatment and viewer 606, which can be altered by the customer. With the components illustrated in FIG. 6, a user may experience a training program.

Returning to FIG. 5, the content module 510 further provides an author interface 514, which is used to generate and/or modify the content of the training courses. The author interface 514 is used by the content managers 530 and 531. The content managers 530 and 531 are exemplary and it is understood that there may be more or less content managers.

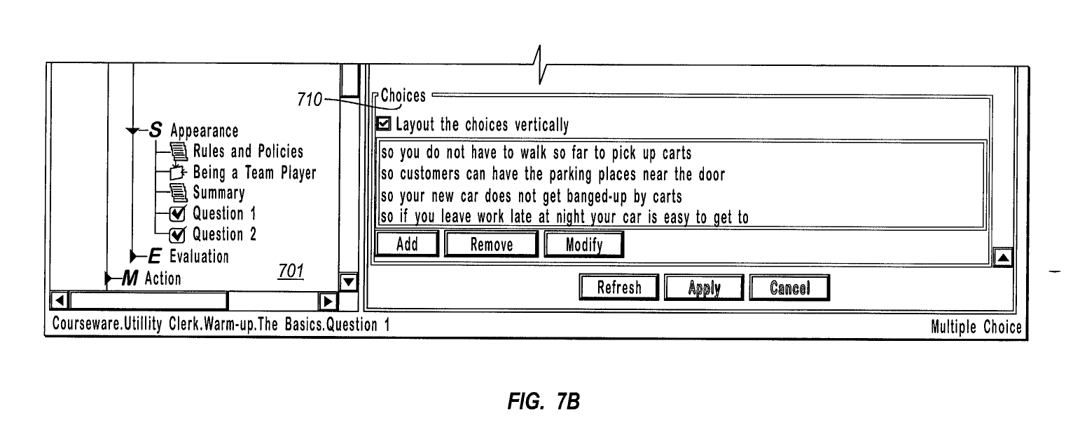

The content manager 530 is used to create/modify the content 502 of the various training courses and FIG. 7 represents an exemplary user interface through which a user may interact with the content of the training courses and also illustrates an exemplary structure for representing courses of the content stored in the database 501 of FIG. 5. Block 701 represents an exemplary structure of the courseware 711. The courseware 711 includes multiple courses including course 712 and course 716 in this example. Each course, as described with reference to FIG. 2, has modules, segments and blocks.

In FIGS. 7A and 7B, block 721 has been selected. Block 721 represents a question and is being edited through a content manager by one or more content authors. The block 721 has various screens through which the block 721 can be modified or updated including, but not limited to, content screen 702, answer screen 703, feedback screen 704, remediation screen 705 and summary screen 706. These screens or modules can be associated with each type of block or template that has been described herein.

With respect to the content screen 702 of the block 721, a user, through a content manager, can alter the context information 707, which has contextual information for the question such as name, display name, description, duration, and help file. The selections 708 of the content screen 702 allows a user to identify how the question may be answered. This example includes options such as allowing a user to mark multiple selections as well as including an “all of the above” selection and/or a “none of the above” selection for the question presented in the block 721.

The question section 709 of the content screen 702 allows the actual question presented to a trainee to be edited and also provides information relating to a layout of the question. In this instance, the question has a vertical layout. The choices section 710 is similar to the question section 709 in that the text of the choices can be inserted or edited. A layout option is also available for the choices section 710.

The remaining screens allow a content author, through a content manager, to detail other types of information that are related to the subject matter of the course, module, segment, or block. The answer screen 703, for example, allows the content author to detail the answer of the question posed through the block 721 in a manner that is similar to how the content screen 702 allows the content author to detail the question presented through the block 721.

Another advantage provided by the present invention is that multiple content authors can edit the same content. In the example shown in FIG. 7 this can occur as follows. A first author is editing the content of the block 721 through the content screen. At the same time, a second author is allowed to edit the content of the block 721 through the answer screen 703. If the second author commits their changes to the content of the block 721, it is permitted because the first author is working on the content screen. Each author is accessing a defined portion of the same content and each author is not working on a separate document, which would require additional work to combine the respective changes of the authors.

Alternatively, if the second author desires to edit through the content screen 702 while the first author is also editing through the content screen 702, the second author is not allowed to commit a change to the content of the block 721 if the first author has committed a change to the content of the block 721 since the second author opened the content of the block 721 for editing. In this situation, the second author may view the changes made by the first author and be given the option of overriding the changes made by the first author or to adapt their changes to the changes made by the first author. When a change is made to the content, other authors who may be editing the same content are notified that they are working on stale data. In this manner, a single block can be updated by one or more authors through the content managers.

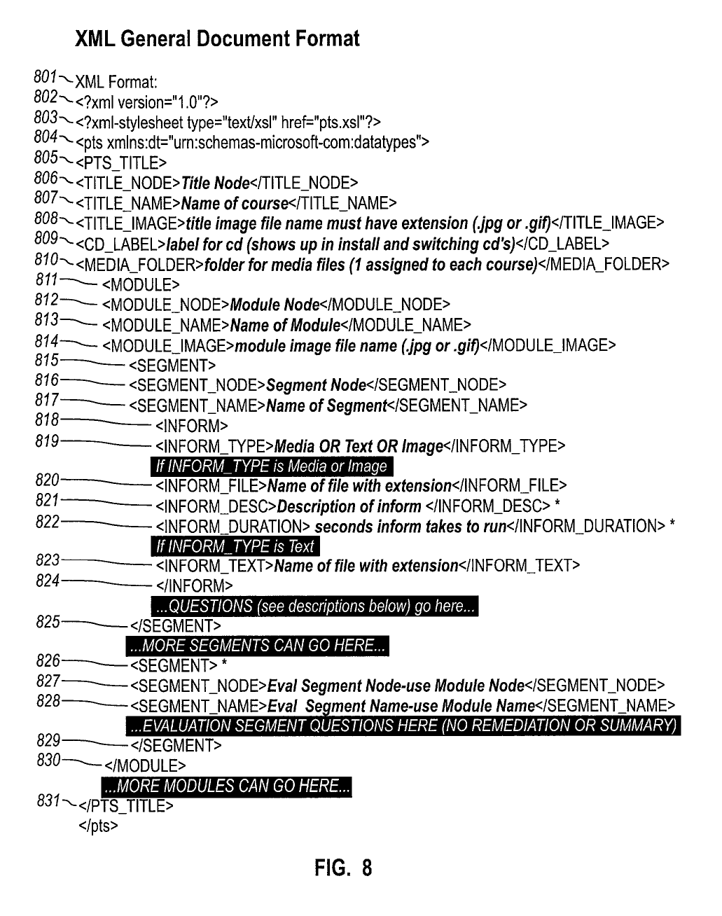

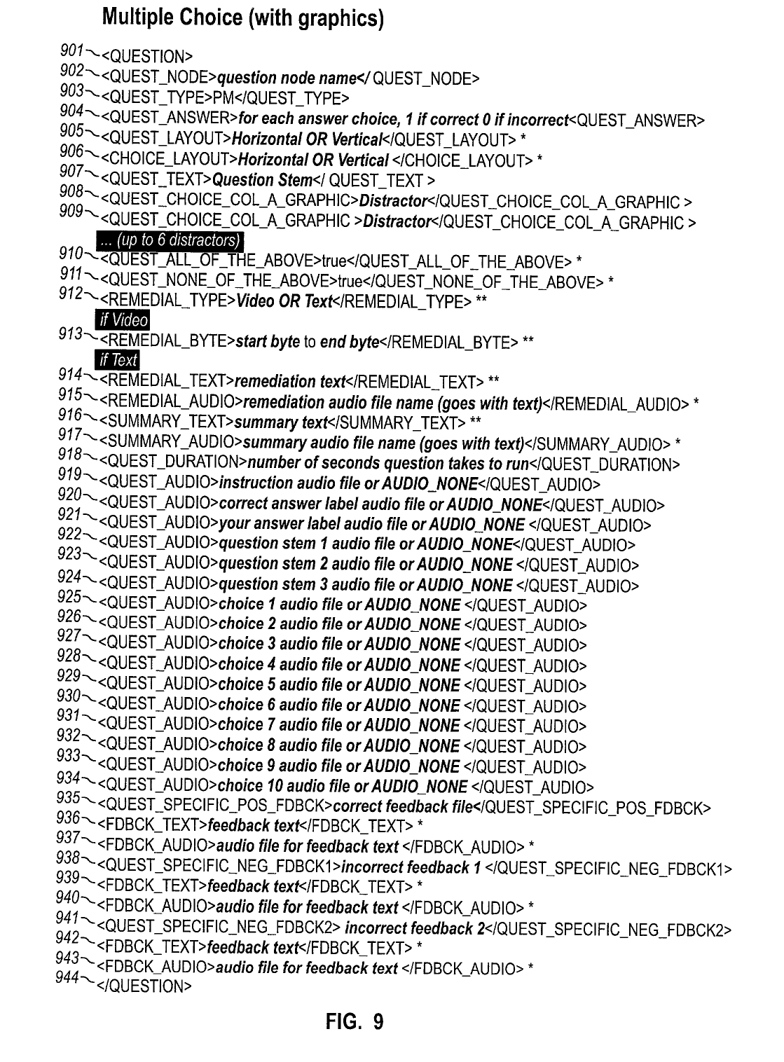

As previously mentioned, the content is separate from the instruction strategy, the viewer, and the delivery technology. FIGS. 8 and 9 provide examples of the content and demonstrate its separateness. FIG. 8 is a block diagram of the general XML format of content for the content of a training course. In particular, FIG. 8 illustrates that the XML data is strictly content and does not contain viewer or delivery technology. The content of FIG. 8 also does not include instructional strategy or graphic treatment. The content illustrated by FIG. 8 is separate and can therefore be adapted to different delivery technologies, viewers, graphic treatments, and instruction strategies, for example. However, the content is not precluded from including some additional information.

FIG. 8 employs a <module> start tag 811 and a </module> end tag 830 that contain and delimit a particular module (similar tags can be used for segments, blocks, courses and the like). Within this module, there are tags used to describe the module name (tag 813), the module node (tag 812), and a module image (tag 814). The module further includes segment tags (815, 825), which also has a segment node tag 816 and a segment name tag 817. Each segment includes inform tags (818, 824). Each inform tag may include, but is not required to have, a type tag 819, a file name tag 820, a description tag 821, and a duration tag 822.

If the information or content being presented using an inform tag is an audio file, then the type tag 819 identifies that the information in the block is audio, the file name tag 820 provides the name of the audio file, the description tag 821 describes the audio file, and the duration tag 822 provides the length of the audio file. In this manner, the content of a training course can be implemented. Information and question blocks can be easily added using the inform tag. Thus, the general XML format of a training course as shown in FIG. 8 is used to delimit, describe, and contain the content that is presented through a viewer to a trainee.

FIG. 9 is a block diagram that illustrates the content of an exemplary multiple choice question that includes graphics. The question begins with the question start tag 901 and ends with the question end tag 944. A <quest_node> tag 902 identifies a question node name and the <quest_type> tag 903 identifies the type of question. The <quest_answer> tag 904 describes attributes of the answer and in this case, provides points based on the answer provided by the trainee. The <quest_layout> tag 905 and the <choice_layout> tag 906 are used by the graphic treatment module when the question is delivered.

The question stem is provided using the <quest_text> tag 907. Other tags are used to delimit content for remediation (tags 913, 914, and 915), question choices with graphics (tags 908-911), audio file tags (917-934), and feedback text and audio (tags 935-943). In this manner, the content for a particular question can be stored in an XML format. The XML format and corresponding tags may vary as the question type varies or as the content varies. For example, the question could be a matching question, or the content may include streaming video and the like. The XML format (although the invention as described herein is not limited to the XML format) ensures that the content is independent of the delivery technology. Because the content is in an XML format and not embedded with the delivery technology, the content can be easily updated and/or edited. The XML format ensures that the content is deliverable in more than one viewer without having to rewrite and/or redevelop the training course.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed and desired to be secured by United States Letters Patent is:

1. In a system wherein a training need has been identified and wherein a training course is needed to address the training need, a method for delivering content of a training course that is independent of a delivery technology, the method comprising steps for:
preparing content for the training course;
selecting a delivery technology for the content of the training course, wherein the delivery technology for the content is independent of the content; and
deploying the training course through the selected delivery technology, wherein a graphic treatment is applied to the content as the content is presented through the selected delivery technology.

2. A method as defined in claim 1, wherein the act of preparing content further comprises an act of developing a curriculum design for the content.

3. A method as defined in claim 1, wherein the act of preparing content further comprises an act of storing the content in a database.

4. A method as defined in claim 1, wherein the content of the training course is organized into one or more of blocks, segments, and modules.

5. A method as defined in claim 4, wherein each of the one or more of blocks, segments and modules is a template, wherein each template is one of an information template, a question template or a container template.

6. A method as defined in claim 1, wherein the act of selecting a delivery further comprises an act of identifying the delivery technology after the training course is complete.

7. A method as defined in claim 1, wherein the delivery technology comprises one or more of a web based delivery technology, a stand alone delivery technology, a print delivery technology, and a wireless delivery technology.

8. A method as defined in claim 1, wherein the act of selecting a graphic treatment for the content further comprises:
an act of selecting a look for the content; and
an act of selecting a feel for the content.

9. A method as defined in claim 1, wherein the act of deploying the training course through the selected delivery further comprises:
an act of generating an XML version of the content; and
an act of identifying a delivery technology for the XML version, wherein the delivery technology comprises one or more of: a print delivery technology, a web based delivery technology, a stand alone delivery technology, and a wireless delivery technology.

10. A method as defined in claim 1, further comprising an act of a user receiving the training course through the selected delivery technology.

11. A method as defined in claim 1, further comprising an act of identifying an instruction strategy for the training course, wherein the instruction strategy can be altered according to characteristics of the population and wherein the instruction strategy is independent of the content and the selected delivery technology.

12. A method as defined in claim 1, further comprising an act of selecting a graphic treatment for the content.

13. A method as defined in claim 12, wherein the graphic treatment is independent of both the content and the delivery technology;

14. In a system wherein a training need has been identified for a population, a method for delivering a training course to the population such that the training course is not subject to changes in the delivery technology but can be used in future delivery technologies as well as current delivery technologies, the method comprising steps for:
from content for the training course that is stored in a database, extracting an XML version of the content; and
presenting the training course to the population through a content module by delivering the XML version of the content to a viewer through the content module, wherein the viewer corresponds to a delivery technology and wherein the XML version of the content is independent of both the viewer and the delivery technology that corresponds to the viewer, wherein a graphic treatment is applied to the XML version of the content.

15. A method as defined in claim 14, further comprising an act of delivering the XML version of the content to a new viewer, wherein the new viewer corresponds to a delivery technology that was unknown when the training course was originally completed.

16. A method as defined in claim 14, further comprising an act of creating the content from a curriculum design.

17. A method as defined in claim 14, further comprising an act of organizing the content into a course, wherein the course comprises one or more modules, wherein each module has one or more segments and each segment has one or more blocks.

18. A method as defined in claim 14, further comprising an act of modifying the content with a content manager through an author interface of the content module.

19. A method as defined in claim 18, further comprising an act or one or more content authors modifying the same content.

20. A computer program product having computer executable instructions for performing the acts recited in claim 14.

21. In a system including a population, wherein a training need has been identified for the population, a training course for use in training the population to address the training need, wherein the training course is not limited to a particular delivery technology but can be deployed to multiple delivery technologies, the training course comprising:
a database having content, wherein the content contains information to be presented to the population during the training course;
a content module including a distributed named object system (DNOS), wherein the DNOS provides access to the content; and
a viewer for each delivery technology, wherein a graphic treatment is applied to the content as the content is delivered to the viewer through the content module.

22. A training course as defined in claim 21, wherein the content includes one or more templates, wherein the each template is one of an information template, a question template, and a container template.

23. A training course as defined in claim 21, wherein each container template contains one or more of an information template, a question template, and another container template.

24. A training course as defined in claim 21, wherein the content is organized into one or more modules, wherein each module includes one or more segments, and wherein each segment includes one or more blocks.

25. A training course as defined in claim 24, wherein each block contains a portion of the information presented to the population in training course.

26. A training course as defined in claim 21, wherein the content is independent of each delivery technology and of each viewer.

27. A training course as defined in claim 21, wherein the content module comprises:
an author interface that provides a content manager with access to the content;
a viewer interface that connects the content module to the viewer; and
a deploy interface.

28. A training course as defined in claim 27, wherein the content includes XML content.

29. A training course as defined in claim 28, wherein the XML content is generated from the content through the deploy interface.

30. A training course as defined in claim 21, wherein the graphic treatment can be changed without altering the content.

31. A training course as defined in claim 21, wherein the graphic treatment includes a look and a feel.

32. A training course as defined in claim 21, further comprising one or more content managers, wherein each content manager is able to modify the content at the same time.

33. A training course as defined in claim 21, further comprising an instruction strategy, wherein the instruction strategy is adaptable to different populations and wherein the instruction strategy determines how the content is presented to the population.

34. In a system including one or more courses stored in a database, a method for updating a portion of a current course, the method comprising acts of:
in a current course, identifying one or more portions of the current course that correspond to one or more portions in another course;
marking the identified one or more portions of both the current course and the other course as alias copies; and
automatically updating other alias copies of the current course whenever the corresponding one or more portions in the other course are updated, whereby all updates to the alias copies occur at substantially the same time.

35. A method as defined in claim 34, further comprising an act of making the alias copies non-alias copies such that the non-alias copies are not updated automatically.

36. A computer program product having computer executable instructions for performing the acts recited in claim 34.

37. A system for delivering a training course to a population, the system comprising:
course content, wherein the course content includes information that is organized into modules, segments, and blocks;
an instruction strategy module, wherein the instruction strategy module determines how the course content of the training course is presented to the population according to one or more criteria;
a viewer that corresponds to a delivery technology, wherein the population receives the training course through the viewer; and
a graphic treatment module having a look and a feel, wherein the look and the feel of the graphic treatment module are applied to the course content as the course content is presented through the viewer to the population.

38. A system as defined in claim 37, wherein the viewer includes one or more of a web based viewer, a stand alone viewer, a print viewer and a wireless viewer.

39. A system as defined in claim 35, wherein the instruction strategy module provides navigation buttons for the content to the population.

40. A system as defined in claim 37, further comprising a content module for providing access to the course content, and wherein the content module deploys an XML version of the course content for use by the viewer.

41. A system as defined in claim 37, wherein the graphic treatment module applies the look and the feel to the course content as the course content is provided to the population.

42. In a system wherein a training need has been identified and wherein a training course is needed to address the training need, a method for authoring content of a training course, the method comprising acts of:
accessing a first portion of the content by a first author, wherein the first author makes first edits to the first portion;
accessing a second portion of the content by a second author, wherein the second author makes second edits to the second portion;
notifying the second author that the second author is working with stale data if the first portion of the content is the same as the second portion of the content and wherein the first author commits the first edits to the first portion before the second author commits the second edits to the first portion; and
committing the second edits of the second author if the first portion of the content is not the same as the second portion of the content.

43. A method as defined in claim 42, wherein the first portion of the content and the second portion of the content is accessed through a first content manager and a second content manager.

44. A method as defined in claim 43, wherein the first content manager provides the first author with access to the first portion of the content through at least one of: a content screen, an answer screen, a feedback screen, a remediation screen, and a summary screen.
